(19) United States
(12) Patent Application Publication
(10) Pub. No.: US 2024/0334209 A1
(43) Pub. Date: Oct. 3, 2024

(54) Methods for Real-Time Wideband RF Waveform and Emission Classification

(71) Applicant: Northeastern University, Boston, MA (US)

(72) Inventors: Daniel UVAYDOV, Allston, MA (US); Milin ZHANG, Portland, ME (US); Salvatore D'ORO, Brookline, MA (US); Tommaso MELODIA, Newton, MA (US); Francesco RESTUCCIA, Boston, MA (US); Clifton Paul ROBINSON, Boston, MA (US)

(21) Appl. No.: 18/620,310

(22) Filed: Mar. 28, 2024

Related U.S. Application Data
(60) Provisional application No. 63/456,455, filed on Mar. 31, 2023.

(51) Int. Cl. H04W 24/02; G06N 3/0464; G06N 3/08; H04B 1/12

(52) U.S. Cl. CPC H04W 24/02; G06N 3/0464; G06N 3/08; H04B 1/12

(57) ABSTRACT

Provided herein are methods and systems for identifying one or more unused or underused portions of a wireless radio frequency (RF) spectrum including providing a multi-label multi-class machine learning classifier trained using a set of RF transmission data, receiving, by a receiver, wireless RF signals in an environment suspected of containing unused or underused portions of said RF spectrum, classifying the received wireless RF signals using the classifier; and identifying unused or underused portions of said RF spectrum.

### CROSS REFERENCE TO RELATED APPLICATIONS

This application claims benefit under 35 U.S.C. § 119(e) of U.S. Provisional Application No. 63/456,455, filed on 31 Mar. 2023, entitled “Methods for Real-Time Wideband RF Waveform and Emission Classification,” the entirety of which is incorporated by reference herein.

### STATEMENT REGARDING FEDERALLY SPONSORED RESEARCH OR DEVELOPMENT

This invention was made with government support under Grant Number 2021-21062400004 awarded by IARPA. The government has certain rights in the invention.

### BACKGROUND

The demand for mobile connectivity is increasing spectrum congestion to unprecedented levels [1]. The number of mobile devices is expected to reach 64 billion by 2025 [2] and global mobile data traffic is expected to reach 288 exabytes per month by 2027 [3]. To improve spectrum usage, technologies such as spectrum sharing will become fundamental components of next-generation wireless systems [4].

A fundamental problem in spectrum sharing is determining in real time which spectrum bands are currently underutilized, also referred to as spectrum sensing [5]. Traditionally, spectrum sensing has focused on determining whether a given channel is busy or free [6-11]. This, however, does not allow implementation of effective spectrum policies where wireless technologies have different access priorities [12]. For this reason, a much more relevant, though significantly more challenging, problem is determining which wireless technology is utilizing a given portion of the spectrum over time and frequency, also known as spectrum classification [13].

Thanks to its ability to learn underlying models describing complex systems directly from data, deep learning has been identified as the ideal candidate to solve a variety of challenges in the wireless domain, where the RF environment is hard to model using closed forms due to its non-deterministic behavior [26, 27]. However, because deep learning-based solutions require large quantities of data to be effective, one approach that finds broad application in the literature is that of using simulators and emulators to generate large synthetic datasets aiming to capture the different behavior of waveforms transmitted over the air under diverse channel conditions [28]. Although entirely relying upon synthetic data is sufficient to validate complex deep learning algorithms and demonstrate their potential in solving complex networking tasks, this approach does not necessarily transfer well to real-world applications where the input data consists of signals collected over the air [14-18].

In this regard, existing work on deep learning for spectrum classification suffers from a number of critical issues. First, previous work has mostly relied on simulations and/or small-scale experimental datasets to evaluate performance [14-18]. This is not without reason. Indeed, labeling real-world wideband spectrum is extremely challenging due to the coexistence of different signals in the same spectrum bands. In addition, the lack of diverse datasets necessarily leads to poor performance under dynamic channel conditions [19, 20]. An illustrative example is shown in FIGS. 1A-1B, where a waveform classifier achieves very high accuracy when tested with data collected by one of the devices used to generate the training dataset (RX 1), but performs poorly when tested with data collected over the air by a new and unseen device (RX 2) whose data was never included in the training dataset.

Recently, it has been shown that utilizing signals collected via experimental data collection campaigns allows deep learning models to better generalize and achieve higher accuracy [29, 30]. For example, prior works [29, 30] have designed and trained a deep learning classifier that uses over the air data to perform waveform classification. However, despite demonstrating the benefits and importance of using over the air data, these works are only able to produce a single-class classification outcome and focus on modulation recognition tasks only, thus only providing incomplete information with respect to spectrum utilization and resulting in lower accuracy when handling interfering and coexisting signals. In short, although it has been demonstrated that feeding as much diverse data (in terms of channel, mobility, and traffic conditions) as possible makes deep learning solutions more reliable, how to collect such data is an open challenge [21].

Some more recent work aims at localizing wireless signals in the spectrum using well-established computer vision approaches used to perform object detection such as You Only Look Once (YOLO), which are used out-of-the-box from those computer vision applications [22, 23]. This approach has several drawbacks. First, it requires the creation of an image out of in-phase/quadrature (I/Q) samples, thus incurring additional latency. This is a critical issue because spectrum needs to be classified almost instantaneously to provide meaningful and actionable inference. Such near-instantaneous actionable inferences are important, for example, for improving spectrum usage efficiency by detecting and filling spectrum holes. Moreover, modern wireless signals such as 5G and LoRa do not neatly conform into the square boxes used by out-of-the-box computer vision systems, as shown in FIGS. 2A-2B. Thus, in such systems, a significant amount of spectrum will be incorrectly classified as occupied, thus leading to poor spectrum efficiency in systems where opportunistic and/or multi-tier spectrum access policies are being implemented [24].

In more detail, while object detection via YOLO is indeed a viable method for computer vision tasks, this approach does not achieve the level of resolution or granularity required for wireless signals. Wireless signals do not necessarily fit neatly into square bounding boxes (e.g., chirp spread spectrum signals). Furthermore, there are wireless technologies whose signals do not fully utilize their allocated spectrum (i.e. LTE, 5G) and bounding boxes used by YOLO and other object detection models cannot accurately depict the under-utilization of these technologies, as shown in FIGS. 2A-2B. This is especially crucial in applications implementing opportunistic spectrum sharing where underutilized portions of the spectrum can be taken advantage of to increase spectrum efficiency.

Another line of prior work focuses on using data augmentation techniques to diversify and extend the scope of datasets collected over the air. Specifically, these works [31, 32] develop data augmentation pipelines for wireless signal classification and have been created with a specific focus on single-label classification tasks, wherein the augmentation process is designed to emulate the effect of diverse channel effects and noise levels on collected signals. Such works, by focusing on single-label classification tasks, do not address the problem of locating and characterizing multiple potentially overlapping wireless signals in wideband applications.

Another prior work [23] curates an over the air dataset that is extended via data augmentation techniques to address wideband spectrum sensing tasks. This prior work develops a spectrum sensing algorithm that uses YOLO-based object detection to identify and localize different waveforms in real-time and in the wild. However, this approach still utilizes and relies on YOLO and thus still suffers from excessive latency and still produces numerous bounding boxes that encompass either empty portions of spectrum or signals belonging to a different class, thereby misclassifying the spectrum. Moreover, despite demonstration of better accuracy results than other prior works, such prior work [23] does not evaluate the portability and generalization of the solution against different radios, sampling rates, and in environments where transmissions are generated by devices not being controlled by experimental design. Such systems remain inaccurate under “in the wild” conditions.

### SUMMARY

Described herein are methods for real-time wideband RF waveform and emission classification using a completely novel approach based on semantic spectrum segmentation, where multiple signals are simultaneously classified and localized in both time and frequency at the I/Q level and by using unprocessed I/Q samples. In the present technology, unlike state-of-the-art computer vision algorithms, non-local blocks are added to combine the spatial features of signals, and thus achieve better performance. In addition, a novel data generation approach is proposed where a limited set of easy-to-collect real-world wireless signals are “stitched together” to generate large-scale, wideband, and diverse datasets. Experimental results obtained on multiple testbeds (including the Arena testbed) using multiple antennas, multiple sampling frequencies, and multiple radios over the course of 3 days show that the approach classifies and localizes signals with a mean intersection over union (IOU) of 96.70% across 5 wireless protocols while performing in real-time with a latency of 2.6 ms. Moreover, it is demonstrated that the present approach based on non-local blocks achieves 7% more accuracy when segmenting the most challenging signals with respect to the state of the art U-Net algorithm.

In one aspect, a method of identifying one or more unused or underused portions of a wireless radio frequency (RF) spectrum is provided. The method includes providing a multi-label multi-class machine learning classifier trained using a set of RF transmission data. The method also includes receiving, by a receiver, wireless RF signals in an environment suspected of containing unused or underused portions of said RF spectrum. The method also includes, classifying the received wireless RF signals using the classifier. The method also includes identifying unused or underused portions of said RF spectrum.

In some embodiments, the method also includes generating said set of RF transmission data for use in training said classifier. In some embodiments, generating said set of RF transmission data for use in training said classifier includes collecting over the air RF signals. In some embodiments, generating said set of RF transmission data for use in training said classifier also includes generating a larger set of RF signals by stitching together the collected RF signals. In some embodiments, the step of classifying comprises a semantic spectrum segmentation process, wherein a plurality of signals are simultaneously classified and localized in both time and frequency at the I/Q level using unprocessed I/Q samples. In some embodiments, the method also includes adding a non-local block to combine spatial features of the received RF signals. In some embodiments, the wireless RF signals in the environment suspected of containing unused or underused portions of said RF spectrum are received by a first receiver. In some embodiments, the over the air RF signals are collected by a second receiver. In some embodiments, the wireless RF signals in the environment suspected of containing unused or underused portions of said RF spectrum are received by a first receiver. In some embodiments, the over the air RF signals are collected by the first receiver.

In some embodiments, the step of generating said set of RF transmission data for use in training said classifier further comprises pre-processing the collected over the air RF signals in a pre-processing pipeline. In some embodiments, the step of pre-processing also includes cropping the each over the air RF signal to remove a silence period before and/or after a signal transmission. In some embodiments, the step of pre-processing also includes applying a bandpass filter to each cropped over the air RF signal extract a signal of interest. In some embodiments, the step of pre-processing also includes converting the signal of interest, by a Fast Fourier Transform, to a filtered signal in a frequency domain. In some embodiments, the step of pre-processing further comprises pruning the filtered signal to remove any frequency components outside of a frequency band of interest to produce a processed signal. In some embodiments, the step of pre-processing further comprises adding the processed signal to a signal bank.

In some embodiments, the step of generating a larger set of RF signals by stitching together the collected RF signals is performed in a dataset generator pipeline and includes generating a random number of signals to be injected into an observable bandwidth. In some embodiments, the step of generating a larger set of RF signals by stitching together the collected RF signals also includes assigning a target class, a corresponding signal type, and a corresponding central frequency to each of the random number of signals to be injected into the observable bandwidth. In some embodiments, the step of generating a larger set of RF signals by stitching together the collected RF signals also includes extracting, for each of the random number of signals to be injected into the observable bandwidth, a signal from a signal bank corresponding to the assigned target class. In some embodiments, the step of generating a larger set of RF signals by stitching together the collected RF signals also includes stitching the extracted signals together by combining the extracted signals via an additive operation. In some embodiments, the method also includes the step of producing one or more labels corresponding to each of the stitched extracted signals. In some embodiments, the method also includes the step of storing the stitched extracted signals and the produced labels in a training dataset.

In another aspect, a spectrum sensor for identifying one or more unused or underused portions of a wireless radio frequency (RF) spectrum is provided. The spectrum sensor includes a receiver configured to receive wireless RF signals in an environment suspected of containing unused or underused portions of said RF spectrum. The spectrum sensor also includes a multi-label multi-class machine learning classifier trained using a set of RF transmission data. The multi-label multi-class machine learning classifier is trained to classify the received wireless RF signals. The multi-label multi-class machine learning classifier is also trained to identify unused or underused portions of said RF spectrum.

In some embodiments, the multi-label multi-class machine learning classifier is further trained to execute a semantic spectrum segmentation process, wherein a plurality of signals are simultaneously classified and localized in both time and frequency at the I/Q level using unprocessed I/Q samples. In some embodiments, the multi-label multi-class machine learning classifier further comprises a non-local block configured to combine spatial features of the received RF signals. In some embodiments, the spectrum sensor also includes a dataset generator for generating said set of RF transmission data for use in training said multi-label multi-class machine learning classifier. In some embodiments, the dataset generator includes a pre-processing pipeline configured to pre-process collected over the air RF signals. In some embodiments, the dataset generator also includes a dataset generator pipeline configured generate a larger set of RF signals by stitching together the pre-processed collected over the air RF signals. In some embodiments, the multi-label multi-class machine learning classifier is a deep learning classifier.

Additional features and aspects of the technology include the following:
1. A method of identifying one or more unused or underused portions of a wireless radio frequency (RF) spectrum, the method comprising the steps of:
   providing a multi-label multi-class machine learning classifier trained using a set of RF transmission data;
   receiving, by a receiver, wireless RF signals in an environment suspected of containing unused or underused portions of said RF spectrum;
   classifying the received wireless RF signals using the classifier; and
   identifying unused or underused portions of said RF spectrum.
2. The method of feature 1, further comprising generating said set of RF transmission data for use in training said classifier by:
   collecting over the air RF signals;
   generating a larger set of RF signals by stitching together the collected RF signals.
3. The method of any of features 1-2, wherein the step of classifying comprises a semantic spectrum segmentation process, wherein a plurality of signals are simultaneously classified and localized in both time and frequency at the I/Q level using unprocessed I/Q samples.
4. The method of feature 3, further comprising adding a non-local block to combine spatial features of the received RF signals.
5. The method of feature 2, wherein:
   the wireless RF signals in the environment suspected of containing unused or underused portions of said RF spectrum are received by a first receiver; and
   the over the air RF signals are collected by a second receiver.
6. The method of feature 2, wherein:
   the wireless RF signals in the environment suspected of containing unused or underused portions of said RF spectrum are received by a first receiver; and the over the air RF signals are collected by the first receiver.
7. The method of any of features 2-6, wherein the step of generating said set of RF transmission data for use in training said classifier further comprises pre-processing the collected over the air RF signals in a pre-processing pipeline.
8. The method of feature 7, wherein the step of pre-processing further comprises:
   cropping the each over the air RF signal to remove a silence period before and/or after a signal transmission; and
   applying a bandpass filter to each cropped over the air RF signal extract a signal of interest.
9. The method of feature 8, wherein the step of pre-processing further comprises converting the signal of interest, by a Fast Fourier Transform, to a filtered signal in a frequency domain.
10. The method of feature 9, wherein the step of pre-processing further comprises pruning the filtered signal to remove any frequency components outside of a frequency band of interest to produce a processed signal.
11. The method of feature 10, wherein the step of pre-processing further comprises adding the processed signal to a signal bank.
12. The method of any of features 2-11, wherein the step of generating a larger set of RF signals by stitching together the collected RF signals is performed in a dataset generator pipeline and further comprises:
   generating a random number of signals to be injected into an observable bandwidth.
13. The method of feature 12, wherein the step of generating a larger set of RF signals by stitching together the collected RF signals further comprises:
assigning a target class, a corresponding signal type, and a corresponding central frequency to each of the random number of signals to be injected into the observable bandwidth.
14. The method of feature 13, wherein the step of generating a larger set of RF signals by stitching together the collected RF signals further comprises:
   extracting, for each of the random number of signals to be injected into the observable bandwidth, a signal from a signal bank corresponding to the assigned target class.
15. The method of feature 14, wherein the step of generating a larger set of RF signals by stitching together the collected RF signals further comprises:
   stitching the extracted signals together by combining the extracted signals via an additive operation.
16. The method of feature 15, further comprising the step of:
   producing one or more labels corresponding to each of the stitched extracted signals; and
   storing the stitched extracted signals and the produced labels in a training dataset.
17. A spectrum sensor for identifying one or more unused or underused portions of a wireless radio frequency (RF) spectrum comprising:
   a receiver configured to receive wireless RF signals in an environment suspected of containing unused or underused portions of said RF spectrum;
   a multi-label multi-class machine learning classifier trained using a set of RF transmission data to:
      classify the received wireless RF signals, and
      identify unused or underused portions of said RF spectrum.
18. The spectrum sensor of feature 17, wherein the multi-label multi-class machine learning classifier is further trained to execute a semantic spectrum segmentation process, wherein a plurality of signals are simultaneously classified and localized in both time and frequency at the I/Q level using unprocessed I/Q samples.
19. The spectrum sensor of feature 18, wherein the multi-label multi-class machine learning classifier further comprises a non-local block configured to combine spatial features of the received RF signals.
20. The spectrum sensor of any of features 17-19, further comprising a dataset generator for generating said set of RF transmission data for use in training said multi-label multi-class machine learning classifier, the dataset generator including:
   a pre-processing pipeline configured to pre-process collected over the air RF signals; and
   a dataset generator pipeline configured generate a larger set of RF signals by stitching together the pre-processed collected over the air RF signals.
21. The spectrum sensor of any of features 17-20, wherein the multi-label multi-class machine learning classifier is a deep learning classifier.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A illustrates a spectrogram in accordance with the prior art, wherein, although some WiFi signals are successfully identified in the spectrogram, many partial and/or obscured signals remain unidentified and unlabeled (shown boxed by a solid line and labeled with question marks).

FIG. 1B illustrates performance degradation in a prior art waveform classifier when the prior art classifier processes data collected by a receiver device other than the receiver device used during a training phase of the classifier. As shown, the prior art waveform classifier may perform well on data collected by the same device used during the training phase (RX 1) but may show poor performance when tested on data collected by a different device (RX 2).

FIGS. 2A-2B illustrate spectrogram analysis of 5G and LoRa signals in accordance with the prior art, wherein misclassification of spectrum is caused because such prior art object detection systems require the construction of an image and thus do not achieve fine-grained I/Q granularity.

FIG. 3 illustrates a functional flow diagram of pre-processing for frequency synchronized signals in accordance with various embodiments.

FIG. 4 illustrates a functional flow diagram for generating a single training sample for a dataset in accordance with various embodiments.

FIG. 5 illustrates a semantic spectrum segmentation architecture using U-Net [25] with a non-local block in accordance with various embodiments.

FIG. 6A illustrates prior art traditional single-label semantic segmentation in the context of visual images.

FIG. 6B illustrates the prior art application of traditional single-label semantic segmentation, not tailored to spectrum sensing tasks, and why such approaches result in information loss.

FIG. 7 illustrates a scalable and portable pipeline for processing larger bandwidths without retraining a segmentation classifier in accordance with various embodiments.

FIG. 8 illustrates a hardware setup used for data collection with different radios, antennas, shown in different testing locations. The signal bank was generated in the laboratory location only using the Arena [35] testbed. Testing data was collected in all locations.

FIG. 9 illustrates a comparison of intersection over union (IoU) results between the semantic spectrum segmentation provided herein and a prior art U-Net model for a plurality of wireless technologies.

FIG. 10A illustrates classification of overlapping WiFi and Zigbee signals in accordance with various embodiments.

FIG. 10B illustrates classification of overlapping LTE and BLE signals in accordance with various embodiments.

FIG. 11A illustrates a spectrogram of data collected at 2.402 GHz (a BLE advertisement channel).

FIG. 11B illustrates a spectrum map of a semi-augmented data generator model output of the semantic spectrum segmentation provided herein as tested on data collected over the air.

FIG. 11C illustrates a spectrum map of an un-augmented data model output of the semantic spectrum segmentation provided herein as tested on data collected over the air.

FIG. 11D illustrates a spectrum map of a synthetic data model output of the semantic spectrum segmentation provided herein as tested on data collected over the air.

FIG. 12A: illustrates spectrograms and output spectrum inference maps for data collected over the air with different radios and antennas at 748 MHz (near LTE band 28)

FIG. 12B: illustrates spectrograms and output spectrum inference maps for data collected over the air with different radios and antennas at 2.437 GHz (WiFi Channel 6).

FIGS. 13A-13B: illustrate a show a spectrogram and a model output map for data collected over the air with a 100 MHz sampling rate from 700-800 MHz. Ideal object detection bounding boxes associated with conventional methods have been added to the output map of FIG. 13B to illustrate how such boxes would result in misclassification of spectrum holes as LTE signals.

FIG. 14A illustrates a spectrogram for data collected over the air in the kitchen area shown in FIG. 8 with an observable bandwidth of 25 MHz at 2.437 GHz.

FIG. 14B illustrates a spectrogram for data collected over the air in the lobby area shown in FIG. 8 with an observable bandwidth of 25 MHz at 2.437 GHz.

FIG. 14C illustrates a model output map for data collected over the air in the kitchen area shown in FIG. 8 with an observable bandwidth of 25 MHz at 2.437 GHz.

FIG. 14D illustrates a model output map for data collected over the air in the lobby area shown in FIG. 8 with an observable bandwidth of 25 MHz at 2.437 GHz.

FIG. 15 illustrates an inference latency comparison between the semantic spectrum segmentation provided herein, YOLOv3, and U-Net as measured on both a CPU and a GPU for different observable bandwidth size values.

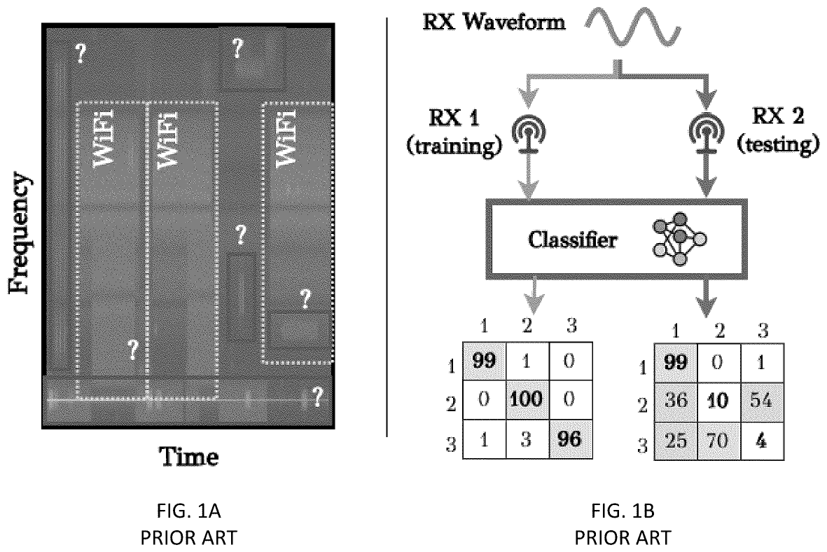

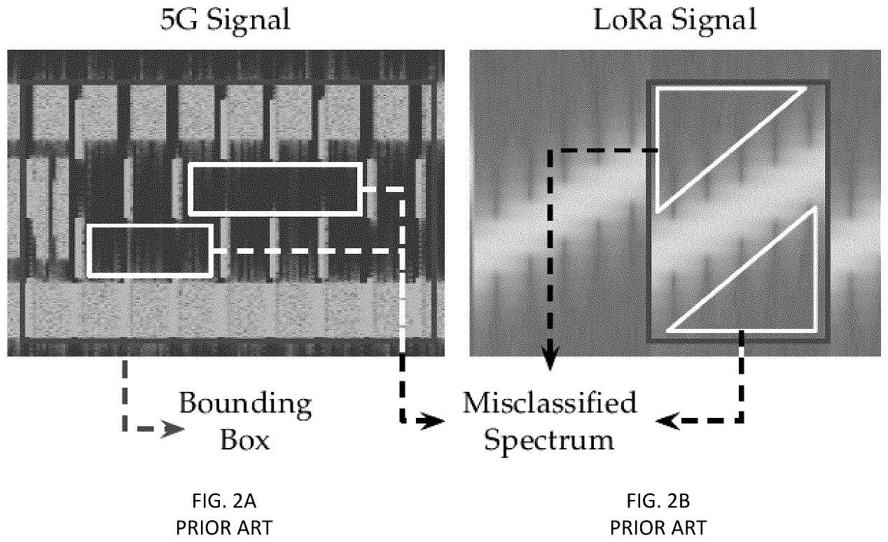

### DETAILED DESCRIPTION

Provided herein are methods and systems for real-time wideband RF waveform and emission classification using semantic spectrum segmentation.

As noted above, spectrum has become an extremely scarce and congested resource. As a consequence, spectrum sensing becomes fundamental to enable the coexistence of different wireless technologies in shared spectrum bands. Most existing work requires spectrograms and out-of-the-box computer vision applications to classify signals. Ultimately, this implies that images need to be continuously created from I/Q samples, thus creating unacceptable latency for real-time operations. In addition, spectrogram-based approaches do not achieve sufficient granularity because they are based on object detection performed on pixels and rectangular bounding boxes.

The present technology addresses the above described issues by introducing the following novel aspects.

In particular, a completely novel approach is presented which is based on semantic spectrum segmentation. Moreover, a novel data generation approach is presented, where a limited set of easy-to-collect real-world wireless signals are “stitched together” to generate large-scale, wideband, and diverse datasets. This approach was extensively evaluated through experimental results obtained on multiple testbeds using multiple antennas, multiple sampling frequencies, and multiple radios. The results show that the present approach classifies and localizes signals with a mean intersection over union (IOU) of 96.70% across 5 wireless protocols while performing in real-time with a latency of 2.6 ms. Moreover, the present approach based on non-local blocks achieves 7% more accuracy when segmenting the most challenging signals with respect to the state of the art U-Net algorithm.

A novel dataset generation pipeline for wideband spectrum sensing applications is provided, which allows generation of large-scale datasets that (i) contain signals collected over the air and are affected by real-world channel conditions; (ii) can be completely labeled; and (iii) can be generated in a time-efficient manner. The approach is based on “stitching” different signals together to create samples where signals are overlapping and affected by real-world noise and interference. It is shown that this pipeline can generate a virtually infinite amount of labeled data starting from only 17 GB of over the air data captured using only two radios in 3 hours and for 5 different wireless technologies (i.e., WiFi, LTE, BLE, LoRa, and ZigBee).

In order to facilitate real-time wideband RF waveform and emission classification the present technology includes a novel custom-tailored machine learning model to perform multi-label multi-class spectrum sensing based on semantic segmentation. Although shown and described herein as being a deep learning model, it will be apparent in view of this disclosure that the use of other suitable machine learning techniques may be appropriate in accordance with various embodiments Furthermore, although the example model provided herein is structured based on the widely known U-Net [25] network for image segmentation, it also includes key differences that cause the present network to perform better for spectrum segmentation. For example, unlike existing spectrum sensing technology, the present technology (i) operates at the I/Q level, instead of creating images; (ii) classifies each and every I/Q sample incoming from the ADC, without creating any bounding boxes, thus increasing classification accuracy significantly; and (iii) only uses 1024 I/Q samples as input, which leads to very low inference time. Moreover, it is shown that the present technology achieves 7% more accuracy than U-Net in the most challenging protocols (Wi-Fi and LTE) while maintaining similarly low latency.

In addition, as described with greater detail below, the inventors have experimentally demonstrated how the proposed semi-augmented dataset generation pipeline can help in making machine learning-based, including deep learning-based solutions more robust against changing conditions and capable of generalizing across different scenarios and deployments. Specifically, it was shown how the pipeline makes the novel wideband spectrum sensing technology disclosed herein more accurate and able to deliver high accuracy even when operating with data collected by different devices, sampling rates, antennas, and under previously unseen network conditions. The results illustrate the ability of the present technology to localize and classify 5 wireless protocols with a mean intersection over union (IOU) of 96.70%. Real-world experiments were also performed with GPUs and it was shown that the present technology takes only 2.6 ms of latency to process 100 MHz of spectrum.

The present technology differs from the prior art described above at least in that: (i) it introduces a semi-augmented data generation pipeline that has been designed to facilitate the generation of over the air wideband datasets including waveforms with diverse technologies, channel and noise conditions, sampling rates, transmission antennas, and center frequency; (ii) it presents a novel multi-class deep learning-based semantic spectrum segmentation technology capable of delivering high-resolution spectrum sensing capabilities that go beyond inaccurate bounding boxes used in YOLO-based solutions, thus offering a more accurate classification and localization of signals and unused portions of the spectrum; and (iii) the work has been validated following a purely over the air approach with signals collected in the wild with multiple radios, sampling rates, center frequencies, and RF environments.

### Semi-Augmented Dataset Generator

Accurate deep learning-based spectrum sensing heavily relies upon the availability of properly labeled and diverse datasets. However, how to build such datasets via over the air data collection is a resource- and time-consuming task. This problem is further exacerbated when the inference objective is not simply classification (e.g., recognizing the modulation of a wireless signal, or determining the presence of a specific waveform), but requires a more fine-grained output. Among others, a relevant spectrum sensing task is multi-label multi-class spectrum sensing, where the goal is to monitor a portion of the spectrum and identify all signals that are being transmitted, along with their bandwidth, technology, and center frequency.

The main challenge is that data must be collected over the air so as to capture realistic channel conditions and prepare the Artificial Intelligence (AI) to operate correctly and with high accuracy in an actual wireless deployment with real radios. Indeed, it has been shown that training deep learning for spectrum sensing on synthetic data generates classifiers that perform close to random guessing when deployed in the wild. Moreover, the dataset should contain signals collected with a diverse set of center frequencies and spectrum bands. In fact, nodes performing spectrum sensing might not always be aware of where signals are being transmitted, and their center frequency will rarely match that of the signals the sensing node is trying to detect, classify and locate. Put simply, training on data that assumes synchronization between sensing and transmission center frequencies results in poor accuracy.

Undoubtedly, it would be possible a large over the air data collection campaign. However, such a task would be extremely difficult and time-consuming due to (i) the many possible combinations to be covered in time and frequency, which exponentially grow in the case of wideband spectrum sensing; and (ii) the need for large portions of spectrum without any interference from external systems. The present technology mitigates the complexity via a combination of over the air data collection and data augmentation. The novel semi-augmented dataset generation process of the present technology addresses the above limitations and enables wideband spectrum sensing applications without the need to scale dataset collection exponentially to achieve good generalization and high accuracy.

At a high level, first, a signal bank (a dataset containing individual signals collected over the air in the absence of interference) is created. The signal bank serves as a seed to create much larger and more diverse datasets. Then, a generator extracts multiple signals from the signal bank and combines them together via a time and frequency shift mechanism, to create a semi-augmented “stitched signal” portraying a more realistic over the air data capture.

### Signal Bank Generation

The signal bank contains a labeled collection of individual signals collected over the air when (i) only one signal is transmitted at a time; (ii) the center frequency and bandwidth are known a priori; and (iii) data collection is performed over a limited and small portion of the spectrum that is constantly monitored to ensure the lack of interference from external systems.

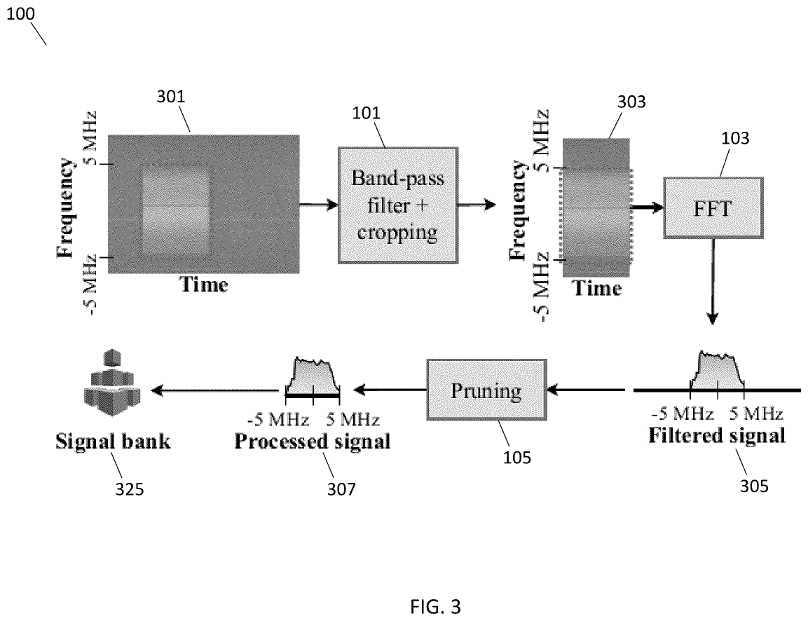

To be added to the signal bank, signals first go through a pre-processing pipeline 100 shown in FIG. 3. Specifically, in a first pre-processing stage 101, a bandpass filter and cropping are applied to received signal data 301, thereby breaking the received signal data 301 up into shorter signals 303 that are (i) cropped to contain only the actual signal transmission (e.g., by removing the silence period before and after data transmission); and (ii) bandpass-filtered to only extract the signal of interest and remove any undesired spurious or interfering signals that may have been recorded during the dataset collection process. In a second pre-processing stage 103, the shorter signals 303 are converted to the frequency domain through a Fast Fourier Transform (FFT) to form a filtered signal 305. Finally, in the third pre-processing stage 105, the filtered signal 305, being in the frequency domain, is pruned so that any frequency components outside of the band of interest occupied by the filtered signal 305 are pruned to produce a processed signal 307, and the remaining I/Qs are added to the signal bank 325. In particular, FIG. 3 shows the pre-processing pipeline 100 as applied for a signal occupying a 10 MHz bandwidth. In some embodiments, the pre-processing pipeline 100 can be repeated multiple times for each signal type so as to generate multiple instances of the same signal with diverse duration and spectrum occupancy.

### Dataset Generation

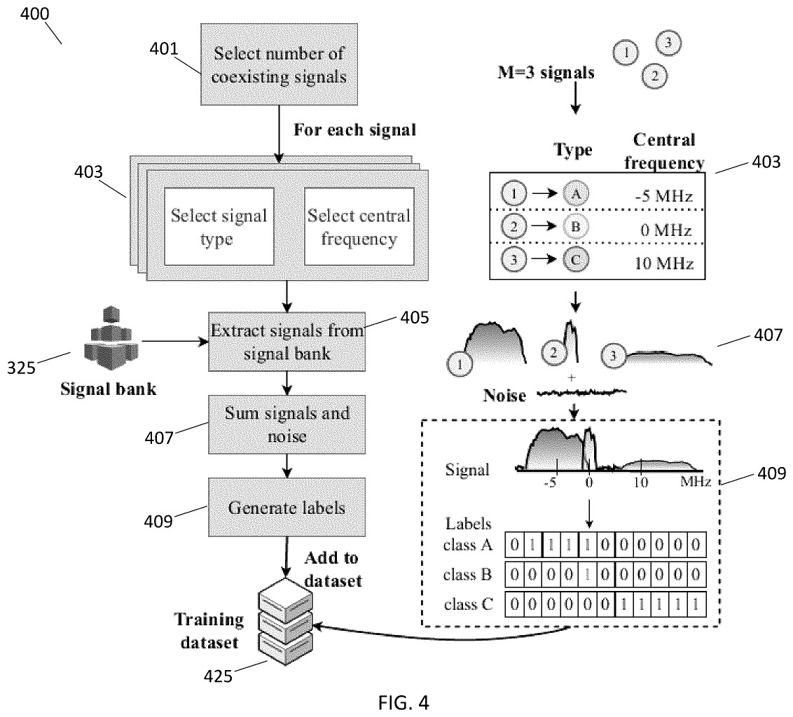

Once the signal bank 325 is generated, a semi-augmented dataset generator pipeline 400 can be employed to combine multiple signals to generate one or more “stitched” wideband signals to be added to a training dataset 425 as shown in FIG. 4. The steps are outlined in FIG. 4, which also includes insets showing an illustrative example of a generated sample and its corresponding label.

As shown, the dataset generator pipeline 400 is provided a set of parameters such as the total number of signal types (e.g., classes such as WiFi, LTE, BLE, among others) that are present in the signal bank, the desired observable bandwidth (the “field of view”) of the receiver, the maximum number of signals which can be simultaneously present at a given time, a probability that the entire observable bandwidth is empty, and a probability that any one of the signals is located at the center frequency. Similarly to real-world spectrum, the pipeline allows signals to overlap partially and/or completely with other signals.

For each composite signal, first, the number M≤nₛ of signals 401 that will be injected into the observable bandwidth is generated. This number is generated at random as follows:

$$M = \{ \begin{matrix}0 , & {P}_{e} \\ {U}^{int} ( 1 , {n}_{s} ) , & 1 - {P}_{e}\end{matrix} \qquad ( 1 )$$

where U^{int}(a, b) represents the value of a uniformly distributed integer random variable taking values in the range [a, b]. From Eq. 1, the band is completely empty with probability Pₑ, or it contains the number M of signals uniformly chosen between 1 and nₛ. The probability Pₑ makes it possible to generate examples that mimic diverse traffic conditions. For example, to emulate a congested spectrum like the one in the industrial, scientific, and medical (ISM) band, Pₑ should be low so as to reflect the fact that such bands are frequently used by several devices at the same time. Similarly, less crowded scenarios can be emulated using a value of Pₑ that is closer to 1.

Upon randomly generating the number M of signals to be included in the current example, the pipeline proceeds in assigning 403 a target class to each of them. Specifically, let C=0, 1, . . . , C be the set of C+1 possible class labels (e.g., where the class 0 is reserved for empty portions of the spectrum and is not included in the signal bank), the target class Cₘ of the m^{th} signal is randomly generated according to

$${C}_{m} ∼ {U}^{int} ( 1 , C ) \qquad ( 2 )$$

Note that Eq. 2 does not include class 0 as unused portions of the spectrum will be computed in the last step of the pipeline. Upon determining the class Cₘ∈C\{0} of signal m, the next step includes extracting 405 at random one instance from the signal bank and placing it in the spectrum. The positioning of the signal strongly depends on its bandwidth bₘ, and its center frequency fₘ. fₘ is randomly chosen so as to ensure that at least a portion of the signal appears within the observable band [−B/2, B/2]. Specifically

$${f}_{m} = \{ \begin{matrix}0 , \\ \begin{matrix}{U}^{cont} ( - \frac{B}{2} , - \frac{{b}_{m}}{2} , \frac{B}{2} , \frac{{b}_{m}}{2} ) , & {1 - {P}_{c}}^{{P}_{c}}\end{matrix}\end{matrix} \qquad ( 3 )$$

where U^{cont}(a, b) represents the value of a uniformly distributed continuous random variable taking values in the range (a, b).

From Eq. 3, the signal is centered at 0 Hz with probability P_{c}, or it is centered at any frequency in

$$( - \frac{B}{2} , - \frac{{b}_{m}}{2} , \frac{B}{2} , \frac{{b}_{m}}{2} )$$

to ensure that the signal is at least partially present within the observable band.

Once all of the M signals have been generated and positioned in the spectrum, they are all combined together via an additive operation 407 (stitching). Additionally, background noise measured over the air from an empty wireless channel is also added as a “background” to fill empty spectrum portions. Upon generation of the sample, labels are produced 409 (see the bottom right inset of FIG. 4) and both are stored in the dataset 425. Because the goal is to produce a high-resolution and accurate labeling, labels were structured as a matrix L of dimension Cₘ×n_{iq}, where n_{iq} is the number of I/Qs in frequency fed as input to the deep learning model. For any given label, each row i corresponds to a class in C, and each column j corresponds to a sub-band k=1, 2, . . . , n_{iq} of the observable bandwidth. Therefore, when a class i is present in a specific sub-band k, the generic element l_{i,j} of the matrix L is such that l_{i,j}=1 if a signal of class i is present in sub-band j, l_{i,j}=0 otherwise. Thus, the resolution of the classification (e.g., how small of a sub-band is able to be classified) is therefore determined by n_{iq}. For example, if B=25 MHz and n_{iq}=1024 then the observable band is broken into n_{iq} bins of size

$$F = \frac{B}{{n}_{i q}} \approx 24 kHz .$$

### Semantic Spectrum Segmentation

One particular application of practical relevance includes using the proposed semi-augmented data generation pipeline to effectively enable the training of deep learning-based solutions for spectrum sensing tasks that are capable of generalizing and delivering high accuracy and reliability. Specifically, the case of wide-band multi-label, multi-class spectrum sensing is the focus, where the goal is to accurately detect, characterize and localize multiple wireless signals with possibly diverse waveforms, bandwidths, power levels, and center frequencies but all coexisting (and possibly overlapping) within the same band of interest.

Since multi-label, multi-class spectrum sensing aims at producing an accurate report of spectrum utilization, in many practical applications, it can be used to identify which portions of the spectrum are being used by a specific technology (e.g., WiFi, Bluetooth, and/or incumbents), while at the same time detect spectrum holes which can be filled opportunistically and in real-time.

### Approach to Semantic Spectrum Segmentation

In contrast to conventional wideband spectrum sensing, the present technology applies semantic segmentation. This approach is used in the computer vision community as a tool to determine the shape of different elements in images or video frames. If compared to YOLO, which outputs a rectangular box around a specific object, semantic segmentation offers a much higher resolution by identifying all pixels that represent the object, therefore better conforming to the object's shape.

In the context of spectrum sensing, semantic segmentation allows the detection of multiple signals simultaneously and in one stage. Among other advantages, semantic segmentation is implemented as a single deep learning classifier that can be optimized end-to-end by feeding I/Q samples in the frequency domain as input, as well as being able to implement the classifier on edge devices (e.g., smartphones) without any specific hardware components.

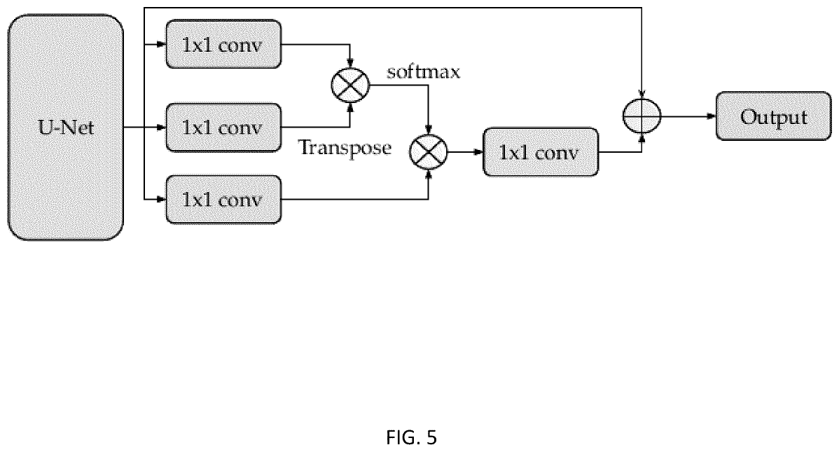

The semantic spectrum segmentation model architecture is shown in FIG. 5. The architecture described herein employs U-Net to handle the majority of the feature extraction. In order to feed I/Q in the frequency domain to the network, U-Net is adapted by converting 2D Convolutional Neural Network (CNN) kernels to 1D. The U-Net-based semantic spectrum sensing network consists of five encoding and decoding blocks. The encoding block is a stack of two 1D convolutional layers with a kernel size 1×3 followed by batch normalization and rectified linear unit (ReLU) activation. A maxpooling layer is used to downsample the encoded features. The decoding block takes both output features from its previous layer and the encoded features from a skip connection. To match the dimensionality of both inputs, an upsampling layer followed by a convolutional kernel is applied to the downsampled features. The feature dimensions are 64, 128, 256, 512, and 1024 for the five encoding and decoding blocks, respectively.

### Non-Local Block

One of the issues with CNNs is that they tend to process groups of features locally, which makes it difficult to capture spatially distant information without the use of feature merging techniques such as the use of pooling layers. Since U-Net has neither global pooling layers nor fully connected layers to mix up features globally, using U-Net in its original form results in performance loss, especially when dealing with wideband signals in the presence of interference. To improve the system performance and increase accuracy, a non-local block [33] is applied after the final decoding block of U-Net so as to integrate a self-attention process. This is achieved via the architecture shown after U-Net in FIG. 5. Specifically, three 1×1 convolutional kernels are used to encode input as Queries Q, Keys K, and Values V, respectively. The self-attention is instead defined as:

$$Attention ( Q , K , V ) = softmax ( \frac{Q {K}^{T}}{\sqrt{d}} ) V \qquad ( 4 )$$

where \sqrt{d} is the embedding dimension of Q and K. The self-attention computes a weighted average of the whole encoded input features V based on an attention map

$$softmax ( \frac{Q {K}^{T}}{\sqrt{d}} ) .$$

Such an attention technique can apply to every encoding and decoding block in U-Net to mix up features globally and improve performance. However, the non-local block requires two matrix multiplication over the whole spatial and feature dimension, which is a relatively computationally heavy task. Such complexity has the potential to result in long inference times that might make the sensing output obsolete by the time it is computed. Thus, because the goal is to develop a system that can operate in real-time and in an actual wireless deployment, a non-local block has been added between the last decoding block and the final multi-labeling layer only.

### Extension to Multi-Label Semantic Segmentation

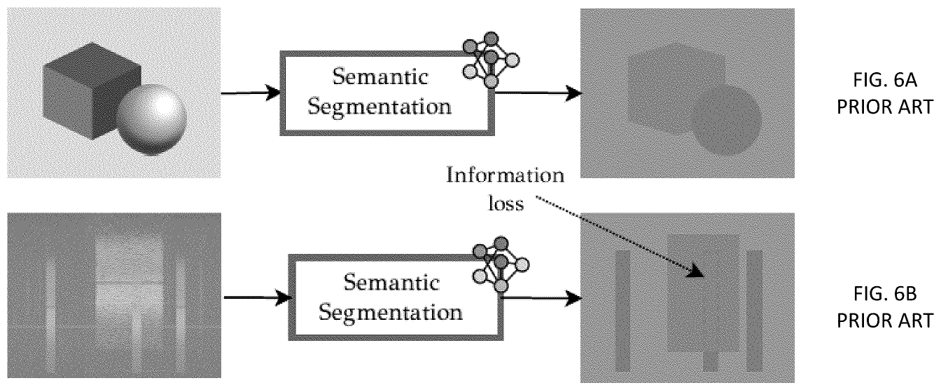

One of the main aspects that make semantic segmentation for spectrum sensing applications significantly different from its traditional application to computer vision tasks is that objects in the foreground always hide those in the background, but the same does not hold for Radio Frequency (RF) applications. As shown in FIG. 6A, pixels in a picture only carry information about foreground objects. However, as shown in FIG. 6B, two wireless signals can overlap in both time and frequency domains and coexist at the same time without necessarily being hidden by other signals in the same frequency bands. The conventional semantic segmentation approach can only assign a single class to each pixel (e.g., the class of the object in the foreground or the signal with the highest power), therefore it cannot be used directly to perform spectrum sensing tasks as it would necessarily result in misclassifications when applied to overlapping wireless signals as shown in FIG. 6B.

To solve this problem, the present technology extends the traditional semantic segmentation architecture to consider the much more complex task of multi-label multi-class classification where the output of the system is a multi-dimensional binary mapping between each I/Q sample and all possible classes. More specifically, the U-Net architecture has been extended such that the input is represented by a sequence of I/Q samples in the frequency domain with size 2×n, where n denotes the number of frequency bins or I/Qs (i.e., the resolution of the classifier), and 2 denotes the real and imaginary part of the complex-values I/Q samples. A 1×1 convolutional kernel at the last layer will generate a C×n output, where C denotes the number of classes. Thus, each row of the output is a binary segmentation map where, for each I/Q sample, information regarding which classes are present or absent in the specific frequency bin can be extracted.

### Achieving Generalization

Ideally, generalization in deep learning is attained via a combination of larger models and larger datasets with diverse data. However, models that are too large do not meet the resource and latency constraints of many wireless applications and devices [34]. Therefore, rather than increase the size of the model, a noise estimation approach is used to compensate for the bias during inference to facilitate further generalization.

That is, while the dataset generator helps to generalize across different bandwidths, center frequencies, and wireless protocols, noise estimation helps to generalize across different wireless devices or radios. Specifically, during training, the minimum values of the smoothed signal power in the frequency domain of each sample are recorded and the average of those values is used as a reference estimate of the noise floor. When testing the model, the input signal is multiplied by a factor that, similarly to normalization, is computed to shift the minimum signal power to the same level as the level estimated across the training dataset. However, such an estimate assumes that there will be an empty hole in the spectrum that only contains noise (this is very common in wideband spectrum sensing scenarios). A more sophisticated noise estimation approach may help to further improve the generalization.

### Scalable and Portable Wide-Band Processing

As mentioned in previous sections, the resolution of the present approach is

$$F = \frac{B}{{n}_{i q}}$$

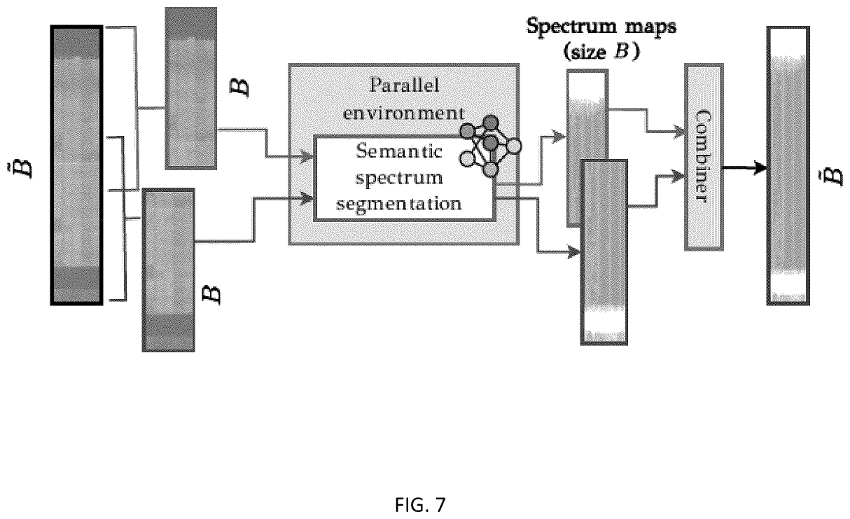

and depends on both the size of the observable bandwidth B and a number of I/Q samples in the frequency domain (e.g., the number of sub-bands used to split the bandwidth B). Since the semantic spectrum segmentation classifier is trained to process an observable band B, it can process signals with smaller bandwidths, but cannot process those with a larger bandwidth due to a mismatch between the size of the input signal, and that of the classifier. To support increasingly larger bandwidths, there are two approaches. A naive approach would be to generate a new dataset with a larger observable bandwidth and train a new classifier. A more scalable and portable approach, followed in the architecture described herein, is instead to leverage parallel processing (e.g., GPU parallelism) and develop a pipeline that can be adapted to any observable bandwidth without requiring to retrain the classifier. The pipeline is illustrated in FIG. 7. Whenever an input is received covering a portion of spectrum \tilde{B} that is larger than the observable bandwidth B of the classifier, a number

$${\tilde{n}}_{i q} = \frac{\tilde{B}}{B} {n}_{i q}$$

samples is first collected to process. Then a set N of partially overlapping samples is generated from the original input such that each sample covers only a portion of size B of the input signal. Each individual sample is then processed individually by the classifier to obtain N outputs of size n_{iq}. These are then combined together via averaging to produce a final output of size ñ_{iq}. The advantage of this pipeline is that (i) it is scalable in that it can leverage parallel processing to speed up the inference time for inputs covering larger bandwidths than B; and (ii) it is portable and general as it can be used for virtually any input of variable bandwidth \tilde{B}, thus making it portable.

### Performance Evaluation

### Generating the Experimental Dataset

To demonstrate the effectiveness of the present technology and how it can transform a few hours' worth of over the air data collection into a dataset that facilitates generalization, a signal bank was generated by collecting data for three hours across three days and using only two radios, a USRP X310 (i.e., the transmitter) and a USRP N320 (i.e., the receiver). Data were collected using five classes (C=5) where each class corresponds to a wireless protocol/technology: WiFi, LTE, BLE, LoRa, ZigBee. The spectrum sensing receiver utilized a sampling rate of 25 MHz which was also the chosen observable bandwidth (B 25 MHz). nₛ=2 and Pₑ=0.05 were set to mimic the case of a congested ISM band where the chances of having an empty channel are very small. Finally, P_{c}=0.5 was set to emulate receivers tuned on commonly used center frequencies (e.g., 2.437 GHz for WiFi channel 6, 2.655 GHz for LTE band 7).

For data collection, a laboratory area was considered that hosts Arena [35], a 64-antenna indoor testbed with ceiling-mounted antennas distributed according to an 8×8 grid covering a 2240 square foot office space. In Arena, antennas are connected to USRP X310 and N320 radios which, together with the ceiling-mounted antennas, are used to collect the over the air data. Also considered were two other areas open to the public: a kitchen area and the main lobby of a building that hosts classes, a cafeteria, and several study areas. These three areas are characterized by diverse RF channel conditions with rich multi-path, interference, and congestion, and represent the ideal candidate for validation.

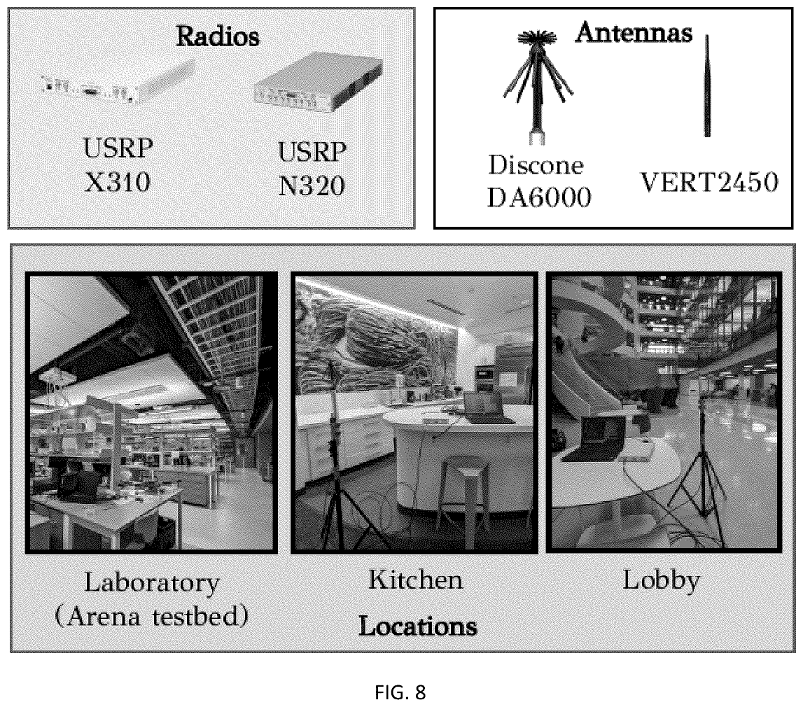

The hardware setup used to collect the data and the data collection locations are illustrated in FIG. 8. The data used to generate the signal bank was collected in the laboratory setup only, while the data used to evaluate the solution was collected in all of the three locations. For the signal bank, data were collected around the 900 MHz, 2.4 GHz, and 2.6 GHz bands. Relatively empty 25 MHz wide bands were found and data collected while monitoring the spectrum. As long as there was no signal interfering with the transmitted signals, the transmissions were considered to be viable for the signal bank once pre-processed.

To evaluate the performance of the semantic segmentation framework Intersection over Union (IoU) is used. IoU is a well-established metric used in segmentation-based computer vision tasks, which is defined as:

$${IoU}_{i} = \frac{\vert {p}_{i} ⋂ {q}_{i} \vert}{\vert {p}_{i} ⋃ {q}_{i} \vert} \qquad ( 5 )$$

where pᵢ and qᵢ are binary arrays describing the predicted and ground-truth labels that describe spectrum occupancy for signal i. |pᵢ∩qᵢ| is the number of true positives, while |pᵢ ∪qᵢ| is the sum of true positives, missed detections, and false alarms.

### Classification Performance

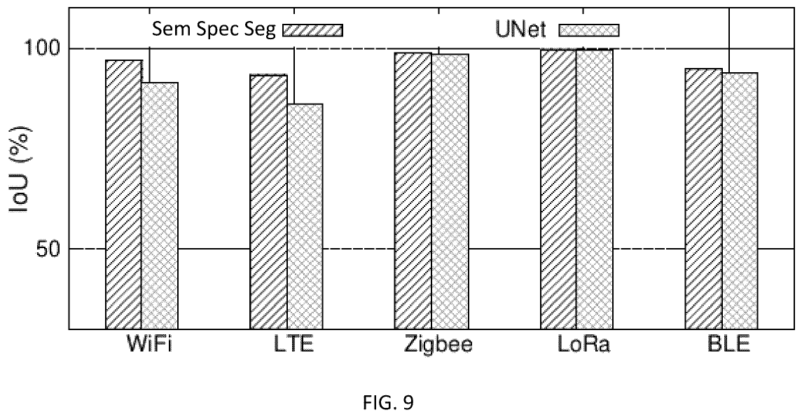

To evaluate the performance of the present semantic segmentation model, it was compared with the original U-Net. The mean IoU were 96.70% and 93.44% for the present technology and U-Net, respectively. FIG. 9 illustrates the IoU performance for each wireless technology, in which the present technology achieved 97.08%, 93.29%, 98.72%, 99.65% and 94.74% for WiFi, LTE, Zigbee, LoRa and BLE signals. On the other hand, the U-Net had 90.31%, 85.20%, 98.40%, 99.59% and 93.72% IoU for the five technologies, respectively. Although the present model is 3% better than U-Net in general, it can achieve 7% better accuracy than U-Net on signals with larger bandwidth such as WiFi and LTE due to the non-local block that was introduced to improve the detection of signals that occupy large portions of spectrum.

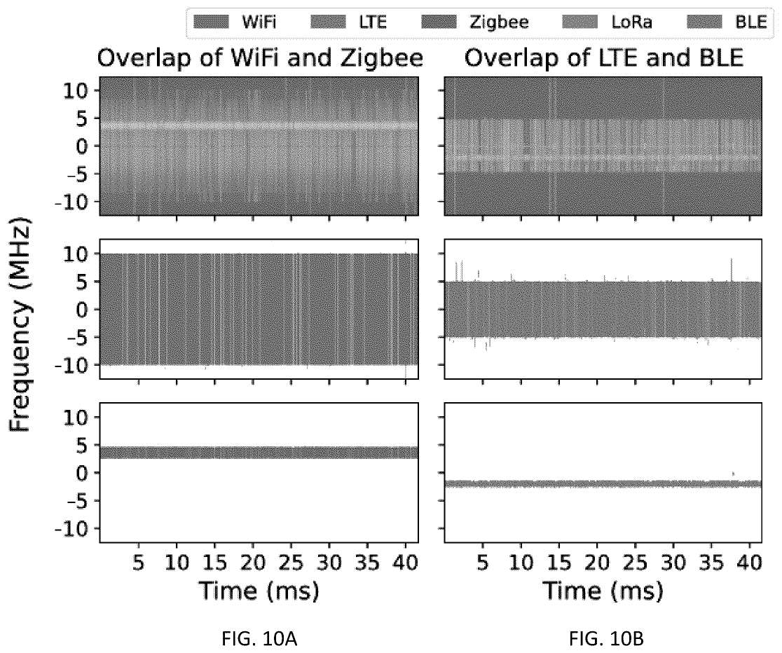

As mentioned above, the present semantic spectrum segmentation classifier outputs a binary array of size C×n_{iq}, which provides the opportunity to determine which type of signal is present in each I/Q sample. In FIGS. 10A-10B, two examples of inputs and outputs are shown to illustrate the ability of the present method in detecting and individually classifying with high-resolution overlapping signals of different technologies. FIG. 10A shows how the classifier is able to effectively classify simultaneously overlapping WiFi and Zigbee signals, while FIG. 10B shows the same but for LTE and BLE overlapping signals.

### Experimental Validation in the Wild

A major objective of the present technology is to attain reliable and effective spectrum sensing in practical use cases over the air and in the wild. For this reason, an extensive data collection campaign was pursued, purely for testing and not for training. The data span multiple days at different locations wherein a variety of over the air signals were collected that were being transmitted at different center frequencies, and with different sampling rates, radios, and antennas. The goal of this campaign was to collect as much data as possible to validate the present model in a variety of real-world deployments, as well as to showcase the benefits that each and every design choice brings to the final accuracy of the spectrum sensing task.

Since the collected signals in this study were collected purely in the wild in a completely uncontrolled RF environment shared by students, workers, visitors, and other wireless devices, it is challenging (if not impossible) to build an accurate and comprehensive ground truth for signals Therefore, the approach used in computer vision problems with unlabeled test data was followed, resorting to graphical comparison of the outputs only.

Performance with Varying Training Datasets

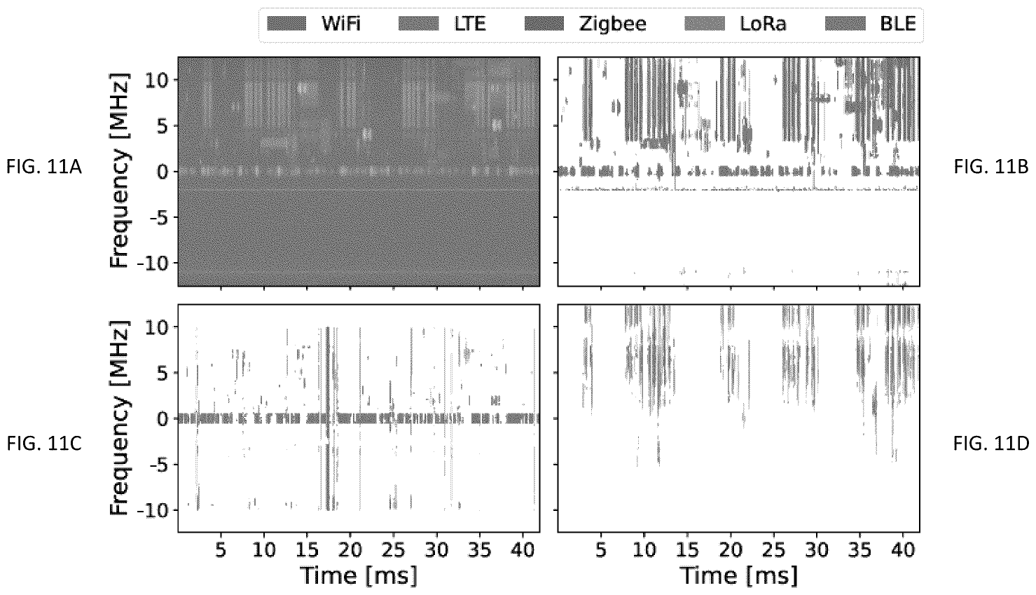

FIGS. 11A-11D show the impact that datasets generated with different methods have on the final outcome of the spectrum sensing classifier. FIG. 11A illustrates a spectrogram of over the air spectrum measurements and FIGS. 11B-11D illustrate spectrum maps of the output of the classifier for instances of the classifier being trained using each of three different datasets. Specifically, FIG. 11B illustrates an augmented dataset obtained using the proposed semi-augmented dataset generation pipeline described above, FIG. 11C illustrates the un-augmented dataset used to generate the augmented data set, and FIG. 11D illustrates a synthetic dataset generated in MATLAB and without any over the air data, containing artificial channel effects.

The signals were collected from the ISM band when the receiver center frequency was on a BLE advertisement channel at 2.402 GHz. It could be clearly seen that the classifier trained on data produced by the augmented dataset generator was able to classify and localize the centered BLE signals better than the same classifiers trained using both the un-augmented and synthetic datasets. Moreover, it was observed that the classifier trained over the augmented data was able to classify and localize signals not necessarily centered at the center frequency of the receiver. The classifier trained on the un-augmented dataset could classify the BLE signal to some extent but misclassified WiFi signals even in those areas of the spectrum where there was no activity at all. The classifier trained on the synthetic dataset, instead, was completely unable to classify any of the over the air signals since synthetic data does not properly capture the characteristics of wireless signals collected in the wild.

Performance with Varying Radios

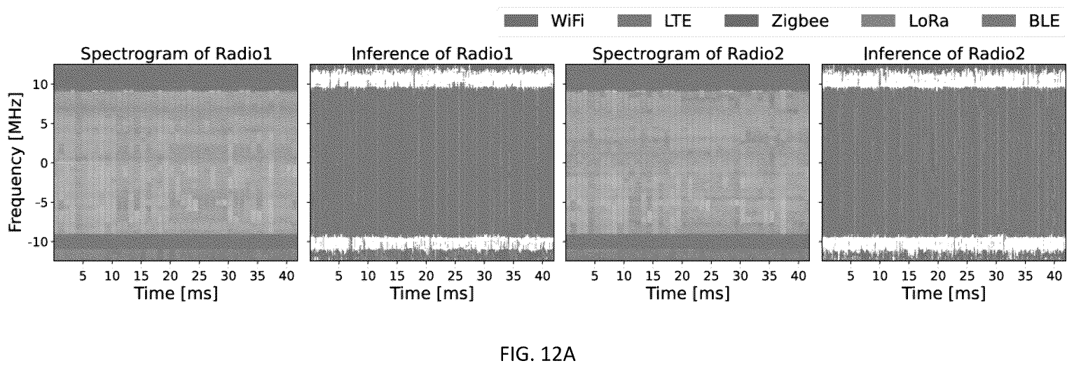

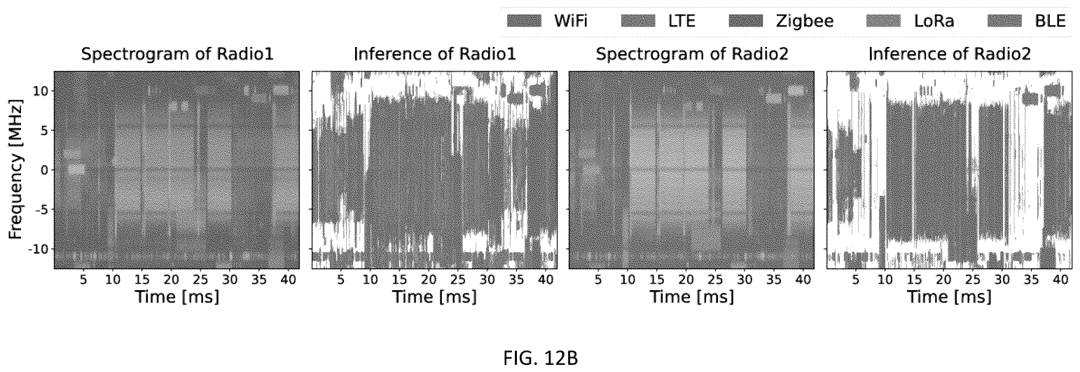

FIGS. 12A-12B show the performance of the classifier on testing data collected from two different radios. Radio 1 was the USRP N320 equipped with the DA6000 antenna (which is also the same setup used to collect the data used to generate the augmented dataset), and Radio 2 was the USRP X310 with a VERT2450 antenna. Each of FIGS. 12A and 12B corresponds to an individual signal but collected at different center frequencies and bands. In this case, FIG. 12A shows spectrograms and output spectrum inference maps of a signal collected in the LTE band at 748 MHz, while FIG. 12B shows spectrograms and output spectrum inference maps of a signal collected having the same center frequency (2.437 GHz) as WiFi channel 6. Indeed, it can be seen that, for both frequencies, the output of the classifier for both radios was very similar and showed good classification performance in both cases. However, it is noted that Radio 1 (the USRP N320) detected more signals than Radio 2 (the USRP X310). For example, Radio 1 produced I/Q samples that make it easier to detect the BLE signals, while Radio 2 could detect them only partially.

Performance with Varying Sampling Rates

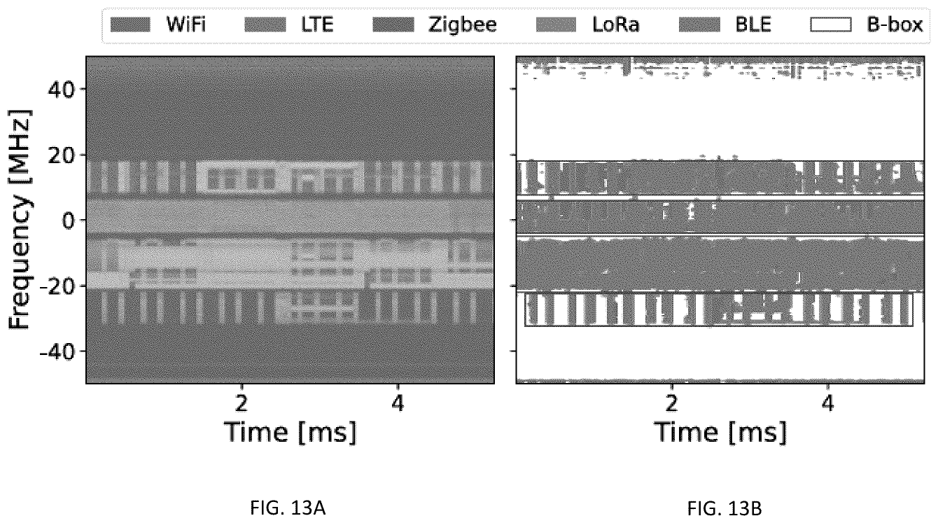

The generalization capability of the classifier was also evaluated by testing it on bandwidths larger than the ones used during the training process. Specifically, data sampled at 100 MHz centered at 750 MHz, a known LTE band, was used. The larger bands were broken up into overlapping pieces and the classifications of the overlapping segments were averaged. This approach was taken to show that it is not necessary to retrain the network for higher bandwidths and instead pieces can either be divided and processed in parallel if a higher sampling capability is available or a sweep across large bands can be used to cover the bandwidths if such sampling capability is not available. FIGS. 13A-13B show a spectrogram and the model output from testing on this data. As shown, there is still good localization and classification performance even for processing at these higher sampling rates. The model can accurately detect and localize the LTE signals which are common in this range of frequencies. Furthermore, a set of red bounding boxes is also shown to reflect a perfect object detection output from YOLO. It is clear to see that rectangular bounding boxes do well in locating LTE transmissions, but mark spectrum holes as LTE signals, whereas, in the present technology, segmentation outputs are more accurate in detecting such holes.

Performance with Varying Locations

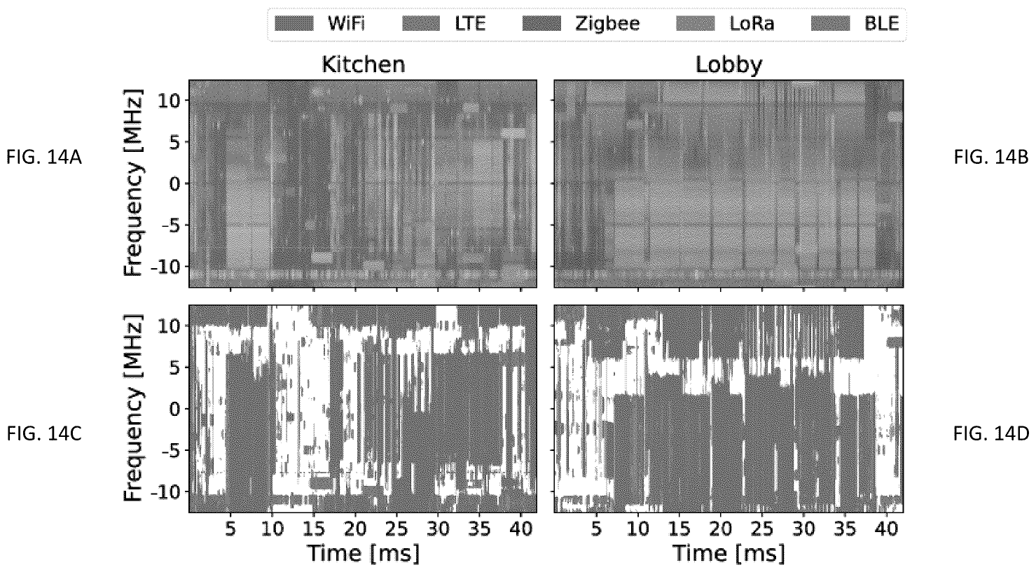

The results presented so far pertained to data collected in a laboratory setup, i.e., the same location used to collect the signal bank. To further validate the generalization of the model, data were collected in other physical locations. FIGS. 14A-14D demonstrate the model performance in two other physical locations at 2.437 GHz (WiFi channel 6) across a bandwidth of B=25 MHz. In particular FIGS. 14A and 14C show the spectrogram and output for the kitchen for the setup shown in FIG. 8, and FIGS. 14B and 14D show the spectrogram and output for the lobby for the setup shown in FIG. 8. In both cases, the model accurately detected the WiFi signals dominating this center frequency and was able to also detect the BLE signals off to the side of the band. Therefore, the present technology is resilient to changes in physical location as well.

### Evaluation of Inference Time

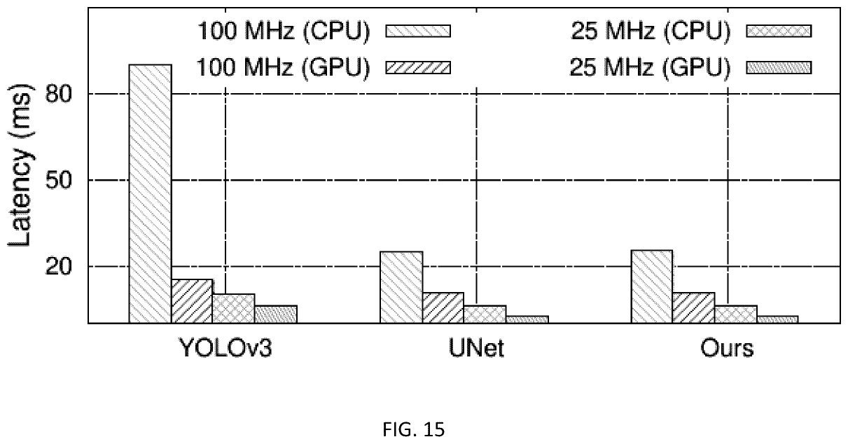

To assess the suitability of the model to deliver real-time spectrum sensing capabilities, its inference time were evaluated on both CPU and GPU and it was compared with YOLOv3 and the original U-Net model. The results were obtained by averaging 1000 independent measurements. FIG. 15 shows the latency tested on different bandwidths. Because YOLOv3 is generally used on 2D images, an input size of 512×512 was assumed for 100 MHz, and it was scaled down linearly to 128×128 for 25 MHz. As expected, the YOLO model had the highest latency because it deals with larger input sizes and requires more complex computations. Only the latency to compute an output from YOLOv3 was reported, without including the time needed to perform non-maximum suppression, i.e., the final step of object detection tasks where the most appropriate bounding box is chosen (which would further increase latency). The difference in latency between the present model and YOLOv3 is substantial, with the present model being able to compute an output up to 31% faster than YOLOv3 when running on a GPU at 100 MHz. However, when the models are executed on CPUs, the present model is 72% faster than YOLOv3. Thus, in multiple respects, the present model significantly outperforms YOLOv3 by a wide margin, whether executed on a CPU or a GPU.

Interestingly, although the present model extends U-Net by adding a non-local block and a multi-label segmenter, its inference time is almost identical to that of the original U-Net model. Specifically, if compared to U-Net, the present model was 0.126 ms slower on CPU (2% increase), and 0.007 ms slower on a GPU (0.25% increase).

### Features of the Present Technology

The present technology offers a fast and accurate solution to classify RF activities across a large portion of the spectrum and identify which portions of the spectrum are being unused (e.g., spectrum holes), so as to enable opportunistic spectrum access.

The technology includes three major components: (i) a semi-augmented dataset generator designed to generate new signals from RF waveforms collected over the air; this is fundamental to train general and accurate deep learning classifiers to characterize spectrum activity; (ii) a novel semantic segmentation architecture that is able to characterize signals that are sparse but occupy a large portion of the spectrum; and (iii) a parallel spectrum processing pipeline that uses GPU parallelism to process large chunks of spectrum in parallel

The present technology uses a deep learning enabled real-time wide-band RF spectrum classification pipeline that allows for generalizable and accurate spectrum sensing. The core innovations of the pipeline include: (i) a semi-augmented dataset generation process that is able to generate a quasi-infinite wireless spectrum dataset from a smaller easier to collect dataset; (ii) a custom multi-label multi-class deep learning model trained from the semi-augmented dataset that is able to classify wireless technologies in the spectrum with very high resolution and is adaptable to multiple bandwidths. This two-step pipeline allows the development of a generalizable and working spectrum sensor that is adaptable to different radios/antennas, locations, sampling rates, and center frequencies as well as solves the dataset collection complexity issue as a large dataset collection campaign is not needed to train a deep learning model. Previous solutions used purely synthetic datasets that do not translate to real world use or involved large dataset collection campaigns. Furthermore, previous deep learning solutions used techniques that did not localize and classify the signal well over the air and were not able to classify overlapping signals. The present technology has applications in spectrum policing, tactical networks, O-RAN, 5G systems, and consumer wireless network/electronics.

One novel feature and innovation of the present technology includes a semi-augmented wireless dataset generation process that can generate virtually infinite amounts of wireless signals starting from a baseline signal bank. The semi-augmented dataset generation process uses a signal bank from a small, easy to collect, over the air dataset to generate a larger dataset with randomized signal bandwidths, center frequencies, and signal protocols. Because the signals from the signal bank are collected over the air, they already experience realistic channel effects and therefore a wireless channel does not need to be simulated. The only requirement for the signals in the signal bank is that they be frequency synchronized with the receiver used to collect them and free of interference. The generator then prepares these signals for the signal bank and uses them to generate a larger dataset. This allows the emulation of a large diverse over the air dataset without the need for collecting said dataset. Furthermore, models trained on this dataset have high performance on un-augmented unseen real world data and therefore translate to real-time application. The parameters of the dataset generator allow users to specify the observable bandwidth, number of signals, signal frequency, and signal content to generate a dataset of their choosing from real signals. The entries of this dataset are single dimension arrays with two channels representing complex signals in the frequency domain. One channel for the real part of the signal (I) and one channel for the imaginary part (Q).

Another novel feature and innovation of the present technology includes a semantic segmentation deep learning model with a self-attention mechanism for classifying wireless signals that might be overlapping or occupy large portions of the spectrum. In particular, a Deep Learning multi-label multi-class semantic segmentation model that takes as input single dimensional arrays representing complex signals in frequency (IQs) of a fixed observable bandwidth and gives a classification to each sub-band or IQ in the observable bandwidth. This classification corresponds to the possible wireless technology that is present in this IQ. The network takes the U-Net architecture used for semantic segmentation tasks generally in computer vision, converts it to take 1D inputs, and adds a self-attention mechanism via a non-local block to improve non-local feature extraction. A multi-label multi-class output is then added to the model, allowing the classifier to detect signals that are overlapping which has not been done before. Furthermore, a sliding window mechanism is implemented that slides the fixed observable bandwidth deep learning model over larger bandwidths to classify them, offering scalable and portable wide-band processing for a variety of sampling rate capabilities.

These novel features, used together, permit the creation of a parallelizable pipeline to process large portions of the spectrum at the same time with high accuracy and low latency. By implementation of such parallelizable pipelines, the present technology also provides the basis for a novel general spectrum sensor that can operate with high accuracy in connection with complex, in the wild, RF environments that are entirely new to the deep learning spectrum sensing model embedded in the spectrum sensor.

Such novel features and innovations provide several advantages and improvements over previous technologies. For example, by use of the semi-augmented wireless dataset generation process, the present technology provides reduced complexity of dataset collection while maintaining large dataset training performance. In addition, by use of the semantic segmentation deep learning model with a self-attention mechanism and the parallelizable pipeline, the present technology offers the ability to classify and localize overlapping signals, the ability to do so over wide bands, and the ability to classify and localize with very high resolution. Furthermore, spectrum sensors trained via the semi-augmented wireless datasets and implemented via the parallelizable pipeline of the present technology are generalizable to different radios/antennas, sampling rates, center frequencies, and locations.

The present technology has several uses and industrial applications. For example, the present technology has utility for spectrum policing, wherein the technology can be used by FCC, SAS to characterize spectrum usage, identify anomalies and improve spectrum allocation policies.

The present technology also has utility for 5G and O-RAN systems. In particular, the technology enables real-time spectrum sensing, which makes it possible to detect unused portions spectrum and utilize them, as well as to identify interference from neighboring cells and move to other frequency bands. For example, use of the present technology in connection with the citizens broadband radio service (CBRS) band may be a particularly impactful, although the present technology is useful in connection with applications in any RF band.

Furthermore, the present technology has utility in connection with tactical networks. In particular, the technology is able to identify anomalies and emitters across a large portion of spectrum. It can also support opportunistic and dynamic spectrum access, which is mandatory in DoD networks. This also applies to private 5G deployments for DoD applications in the CBRS band. Still further, the present technology has utility in connection with consumer wireless networks/electronics and non-terrestrial networks.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

### REFERENCES

[1] Federal Communications Commission (FCC), “Spectrum Crunch.” https://www.fcc.gov/general/spectrum-crunch.
[2] Ericsson, “Ericsson Mobility Report,” tech. rep., November 2021.
[3] 5G Americas, “5g: The future of iot,” tech. rep., 5G Americas, Bellevue, Washington, July 2019.
[4] L. Zhang, M. Xiao, G. Wu, M. Alam, Y.-C. Liang, and S. Li, “A Survey of Advanced Techniques for Spectrum Sharing in 5G Networks,” IEEE Wireless Communications, vol. 24, no. 5, pp. 44-51, 2017.
[5] Y. Arjoune and N. Kaabouch, “A comprehensive survey on spectrum sensing in cognitive radio networks: Recent advances, new challenges, and future research directions,” Sensors, vol. 19, no. 1, p. 126, 2019.
[6] X. Jin and Y. Zhang, “Privacy-preserving Crowdsourced Spectrum Sensing,” IEEE/ACM Transactions on Networking, vol. 26, no. 3, pp. 1236-1249, 2018.
[7] H. Qi, X. Zhang, and Y. Gao, “Channel Energy Statistics Learning in Compressive Spectrum Sensing,” IEEE Transactions on Wireless Communications, vol. 17, no. 12, pp. 7910-7921, 2018.
[8] C. Liu, J. Wang, X. Liu, and Y.-C. Liang, “Deep CM-CNN for Spectrum Sensing in Cognitive Radio,” IEEE Journal on Selected Areas in Communications, vol. 37, no. 10, pp. 2306-2321, 2019.
[9] H. Qi, X. Zhang, and Y. Gao, “Low-Complexity Subspace-Aided Compressive Spectrum Sensing Over Wideband Whitespace,” IEEE Transactions on Vehicular Technology, vol. 68, no. 12, pp. 11762-11777, 2019.
[10] D. Chew and A. B. Cooper, “Spectrum Sensing in Interference and Noise Using Deep Learning,” in Annual Conference on Information Sciences and Systems (CISS), pp. 1-6, IEEE, 2020.
[11] D. Uvaydov, S. D'Oro, F. Restuccia, and T. Melodia, “DeepSense: Fast Wideband Spectrum Sensing Through Real-Time In-the-Loop Deep Learning,” in Proc. of IEEE INFOCOM, pp. 1-10, 2021.
[12] L. Baldesi, F. Restuccia, and T. Melodia, “ChARM: NextG Spectrum Sharing Through Data-driven Real-time O-RAN Dynamic Control,” in Proceedings of IEEE INFOCOM, pp. 240-249, IEEE, 2022.
[13] Q. Mao, F. Hu, and Q. Hao, “Deep Learning for Intelligent Wireless Networks: A Comprehensive Survey,” IEEE Communications Surveys & Tutorials, vol. 20, no. 4, pp. 2595-2621, 2018.
[14] G. C. Sobabe, Y. Song, X. Bai, and B. Guo, “A cooperative spectrum sensing algorithm based on unsupervised learning,” in 2017 10th International Congress on Image and Signal Processing, BioMedical Engineering and Informatics (CISP-BMEI), pp. 1-6, 2017.
[15] S. Rajendran, W. Meert, D. Giustiniano, V. Lenders, and S. Pollin, “Deep learning models for wireless signal classification with distributed low-cost spectrum sensors,” IEEE Transactions on Cognitive Communications and Networking, vol. 4, no. 3, pp. 433-445, 2018.
[16] Z. Chen, H. Cui, J. Xiang, K. Qiu, L. Huang, S. Zheng, S. Chen, Q. Xuan, and X. Yang, “Signet: A novel deep learning framework for radio signal classification,” IEEE Transactions on Cognitive Communications and Networking, vol. 8, no. 2, pp. 529-541, 2022.
[17] A. Vagollari, V. Schram, W. Wicke, M. Hirschbeck, and W. Gerstacker, “Joint detection and classification of rf signals using deep learning,” in 2021 IEEE 93rd Vehicular Technology Conference (VTC2021-Spring), pp. 1-7, IEEE, 2021.
[18] N. Soltani, V. Chaudhary, D. Roy, and K. Chowdhury, “Finding waldo in the cbrs band: Signal detection and localization in the 3.5 ghz spectrum,” in GLOBECOM 2022-2022 IEEE Global Communications Conference, pp. 4570-4575, IEEE, 2022.
[19] F. Restuccia, S. D'Oro, A. Al-Shawabka, M. Belgiovine, L. Angioloni, S. Ioannidis, K. Chowdhury, and T. Melodia, “DeepRadioID: Real-Time Channel-Resilient Optimization of Deep Learning-based Radio Fingerprinting Algorithms,” Proc. of ACM International Symposium on Mobile Ad Hoc Networking and Computing (MobiHoc), 2019.
[20] S. D'Oro, F. Restuccia, and T. Melodia, “Can You Fix My Neural Network?Real-Time Adaptive Waveform Synthesis for Resilient Wireless Signal Classification,” in Proc. of IEEE Conference on Computer Communications (INFOCOM), (Vancouver, BC, Canada), May 2021.
[21] A. Al-Shawabka, F. Restuccia, S. D'Oro, T. Jian, B. C. Rendon, N. Soltani, J. Dy, K. Chowdhury, S. Ioannidis, and T. Melodia, “Exposing the Fingerprint: Dissecting the Impact of the Wireless Channel on Radio Fingerprinting,” Proc. of IEEE Conference on Computer Communications (INFOCOM), 2020.
[22] S. Kayraklik, Y. Alagöz, and A. F. Co kun, “Application of object detection approaches on the wideband sensing problem,” in 2022 IEEE International Black Sea Conference on Communications and Networking (BlackSeaCom), pp. 341-346, IEEE, 2022.
[23] H. N. Nguyen, M. Vomvas, T. D. Vo-Huu, and G. Noubir, “Wrist: Wideband, real-time, spectro-temporal rf identification system using deep learning,” IEEE Transactions on Mobile Computing, 2023.
[24] Federated Wireless, “Citizens Broadband Radio Service (CBRS) Shared Spectrum: An Overview.” https://www.federatedwireless.com/wp-content/uploads/2017/09/CBRS-Spectrum-Sharing-Overview.pdf, 2018.
[25] O. Ronneberger, P. Fischer, and T. Brox, “U-net: Convolutional networks for biomedical image segmentation,” in Medical Image Computing and Computer-Assisted Intervention-MICCAI 2015: 18th International Conference, Munich, Germany, Oct. 5-9, 2015, Proceedings, Part III 18, pp. 234-241, Springer, 2015.
[26] J. Jagannath, N. Polosky, A. Jagannath, F. Restuccia, and T. Melodia, “Machine learning for wireless communications in the internet of things: A comprehensive survey,” Ad Hoc Networks, vol. 93, p. 101913, 2019.
[27] N. C. Luong, D. T. Hoang, S. Gong, D. Niyato, P. Wang, Y.-C. Liang, and D. I. Kim, “Applications of deep reinforcement learning in communications and networking: A survey,” IEEE Communications Surveys & Tutorials, vol. 21, no. 4, pp. 3133-3174, 2019.
[28] X. Li, F. Dong, S. Zhang, W. Guo, et al., “A survey on deep learning techniques in wireless signal recognition,” Wireless Communications and Mobile Computing, vol. 2019, 2019.
[29] T. J. O'Shea, T. Roy, and T. C. Clancy, “Over-the-air deep learning based radio signal classification,” IEEE Journal of Selected Topics in Signal Processing, vol. 12, no. 1, pp. 168-179, 2018.
[30] S. Soltani, Y. E. Sagduyu, R. Hasan, K. Davaslioglu, H. Deng, and T. Erpek, “Real-time and embedded deep learning on fpga for rf signal classification,” in MILCOM 2019-2019 IEEE Military Communications Conference (MILCOM), pp. 1-6, IEEE, 2019.
[31] N. Soltani, K. Sankhe, J. Dy, S. Ioannidis, and K. Chowdhury, “More is better: Data augmentation for channel-resilient rf fingerprinting,” IEEE Communications Magazine, vol. 58, no. 10, pp. 66-72, 2020.
[32] L. Huang, W. Pan, Y. Zhang, L. Qian, N. Gao, and Y. Wu, “Data augmentation for deep learning-based radio modulation classification,” IEEE access, vol. 8, pp. 1498-1506, 2019.
[33] X. Wang, R. Girshick, A. Gupta, and K. He, “Non-local neural networks,” in Proceedings of the IEEE conference on computer vision and pattern recognition, pp. 7794-7803, 2018.
[34] B. Azari, H. Cheng, N. Soltani, H. Li, Y. Li, M. Belgiovine, T. Imbiriba, S. D'Oro, T. Melodia, Y. Wang, et al., “Automated deep learning-based wide-band receiver,” Computer Networks, vol. 218, p. 109367, 2022.
[35] L. Bertizzolo, L. Bonati, E. Demirors, A. Al-shawabka, S. D'Oro, F. Restuccia, and T. Melodia, “Arena: A 64-antenna sdr-based ceiling grid testing platform for sub-6 ghz 5g-and-beyond radio spectrum research,” Computer Networks, vol. 181, p. 107436, 2020.

What is claimed is:

1. A method of identifying one or more unused or underused portions of a wireless radio frequency (RF) spectrum, the method comprising the steps of:
providing a multi-label multi-class machine learning classifier trained using a set of RF transmission data;
receiving, by a receiver, wireless RF signals in an environment suspected of containing unused or underused portions of said RF spectrum;
classifying the received wireless RF signals using the classifier; and
identifying unused or underused portions of said RF spectrum.

2. The method of claim 1, further comprising generating said set of RF transmission data for use in training said classifier by:
collecting over the air RF signals;
generating a larger set of RF signals by stitching together the collected RF signals.

3. The method of claim 1, wherein the step of classifying comprises a semantic spectrum segmentation process, wherein a plurality of signals are simultaneously classified and localized in both time and frequency at the I/Q level using unprocessed I/Q samples.

4. The method of claim 3, further comprising adding a non-local block to combine spatial features of the received RF signals.

5. The method of claim 2, wherein:
the wireless RF signals in the environment suspected of containing unused or underused portions of said RF spectrum are received by a first receiver; and
the over the air RF signals are collected by a second receiver.

6. The method of claim 2, wherein:
the wireless RF signals in the environment suspected of containing unused or underused portions of said RF spectrum are received by a first receiver; and
the over the air RF signals are collected by the first receiver.

7. The method of claim 2, wherein the step of generating said set of RF transmission data for use in training said classifier further comprises pre-processing the collected over the air RF signals in a pre-processing pipeline.

8. The method of claim 7, wherein the step of pre-processing further comprises:
cropping the each over the air RF signal to remove a silence period before and/or after a signal transmission; and
applying a bandpass filter to each cropped over the air RF signal extract a signal of interest.

9. The method of claim 8, wherein the step of pre-processing further comprises converting the signal of interest, by a Fast Fourier Transform, to a filtered signal in a frequency domain.

10. The method of claim 9, wherein the step of pre-processing further comprises pruning the filtered signal to remove any frequency components outside of a frequency band of interest to produce a processed signal.

11. The method of claim 10, wherein the step of pre-processing further comprises adding the processed signal to a signal bank.

12. The method of claim 2, wherein the step of generating a larger set of RF signals by stitching together the collected RF signals is performed in a dataset generator pipeline and further comprises:
generating a random number of signals to be injected into an observable bandwidth.

13. The method of claim 12, wherein the step of generating a larger set of RF signals by stitching together the collected RF signals further comprises:
assigning a target class, a corresponding signal type, and a corresponding central frequency to each of the random number of signals to be injected into the observable bandwidth.

14. The method of claim 13, wherein the step of generating a larger set of RF signals by stitching together the collected RF signals further comprises:
extracting, for each of the random number of signals to be injected into the observable bandwidth, a signal from a signal bank corresponding to the assigned target class.

15. The method of claim 14, wherein the step of generating a larger set of RF signals by stitching together the collected RF signals further comprises:
stitching the extracted signals together by combining the extracted signals via an additive operation.

16. The method of claim 15, further comprising the step of:
producing one or more labels corresponding to each of the stitched extracted signals; and
storing the stitched extracted signals and the produced labels in a training dataset.

17. A spectrum sensor for identifying one or more unused or underused portions of a wireless radio frequency (RF) spectrum comprising:
a receiver configured to receive wireless RF signals in an environment suspected of containing unused or underused portions of said RF spectrum;
a multi-label multi-class machine learning classifier trained using a set of RF transmission data to:
classify the received wireless RF signals, and
identify unused or underused portions of said RF spectrum.

18. The spectrum sensor of claim 17, wherein the multi-label multi-class machine learning classifier is further trained to execute a semantic spectrum segmentation process, wherein a plurality of signals are simultaneously classified and localized in both time and frequency at the I/Q level using unprocessed I/Q samples.

19. The spectrum sensor of claim 18, wherein the multi-label multi-class machine learning classifier further comprises a non-local block configured to combine spatial features of the received RF signals.

20. The spectrum sensor of claim 17, further comprising a dataset generator for generating said set of RF transmission data for use in training said multi-label multi-class machine learning classifier, the dataset generator including:
a pre-processing pipeline configured to pre-process collected over the air RF signals; and
a dataset generator pipeline configured generate a larger set of RF signals by stitching together the pre-processed collected over the air RF signals.

21. The spectrum sensor of claim 17, wherein the multi-label multi-class machine learning classifier is a deep learning classifier.
